(19) United States
(12) Patent Application Publication
(10) Pub. No.: US 2020/0064550 A1
(43) Pub. Date: Feb. 27, 2020

(54) INTERMITTENTLY-COUPLED TYPE OPTICAL FIBER RIBBON, MANUFACTURING METHOD THEREOF, OPTICAL FIBER CABLE, AND OPTICAL FIBER CORD

(71) Applicant: SUMITOMO ELECTRIC INDUSTRIES, LTD., Osaka-shi, Osaka (JP)

(72) Inventors: Fumiaki SATO, Yokohama-shi, Kanagawa (JP); Fumikazu YOSHIZAWA, Yokohama-shi, Kanagawa (JP); Yoshiaki NAGAO, Yokohama-shi, Kanagawa (JP)

(73) Assignee: SUMITOMO ELECTRIC INDUSTRIES, LTD., Osaka-shi, Osaka (JP)

(21) Appl. No.: 16/466,689

(22) PCT Filed: Nov. 27, 2017
(86) PCT No.: PCT/JP2017/042401

§ 371 Date: Jun. 5, 2019

(30) Foreign Application Priority Data
Dec. 6, 2016 (JP) 2016-236568

(51) Int. Cl. G02B 6/26; G02B 6/44

(52) U.S. Cl. CPC G02B 6/262; G02B 6/443; G02B 6/448

(57) ABSTRACT

An intermittently-coupled type optical fiber ribbon in which a plurality of ribbon type paired optical fibers each of which is integrally formed by bringing two optical fibers into contact with each other are arranged in parallel, and a coupling part in which adjacent ribbon type paired optical fibers are connected to each other and a non-coupling part in which ribbon type paired optical fibers are not connected are intermittently provided in a longitudinal direction, wherein an outer diameter dimension of the optical fiber is 0.22 mm or less, and a center distance of optical fibers adjacent with the coupling part interposed therebetween between the adjacent ribbon type paired optical fibers is 0.28±0.03 mm.

### TECHNICAL FIELD

The present invention relates to an intermittently-coupled type optical fiber ribbon, an optical fiber cable, an optical fiber cord, and a manufacturing method of the intermittently-coupled type optical fiber ribbon. The application is based upon and claims the benefit of priority from the prior Japanese Patent Application No. 2016-236568 filed on Dec. 6, 2016, the entire contents of which are incorporated herein by reference.

### BACKGROUND ART

An intermittently-coupled type optical fiber ribbon is known which a coupling part in which adjacent optical fibers are connected by an adhesive resin and a non-coupling part in which adjacent optical fibers are not connected by an adhesive resin are intermittently provided in a longitudinal direction in a state where a plurality of optical fibers are arranged in parallel (for example, see Patent Documents 1 to 3).

### PRIOR ART DOCUMENT

### Patent Document

Patent Document 1: Japanese Patent Application Publication No. 2004-206048

Patent Document 2: Japanese Patent Application Publication No. 2004-206048

Patent Document 3: Japanese Patent Application Publication No. 2013-88617

### SUMMARY OF INVENTION

An aspect of the present disclosure is an intermittently-coupled type optical fiber ribbon in which a plurality of ribbon type paired optical fibers each of which is integrally formed by bringing two optical fibers into contact with each other are arranged in parallel, and a coupling part in which adjacent ribbon type paired optical fibers are connected to each other and a non-coupling part in which ribbon type paired optical fibers are not connected are intermittently provided in a longitudinal direction, wherein

an outer diameter dimension of the optical fiber is 0.22 mm or less, and a center distance of optical fibers adjacent with the coupling part interposed therebetween between the adjacent ribbon type paired optical fibers is 0.28±0.03 mm.

An aspect of the present disclosure is an optical fiber cable comprising:

a cylindrical tube; and

a plurality of intermittently-coupled type optical fiber ribbons according to the above, wherein

the plurality of intermittently-coupled type optical fiber ribbons are covered with the tube.

An aspect of the present disclosure is an optical fiber cable comprising:

a slot rod having a plurality of slot grooves; and

the plurality of intermittently-coupled type optical fiber ribbons according to the above, wherein

the plurality of intermittently-coupled type optical fiber ribbons are housed in each of the slot grooves.

An aspect of the present disclosure is an optical fiber cord comprising:

a jacket; and

the intermittently-coupled type optical fiber ribbon according to the above, wherein

the intermittently-coupled type optical fiber ribbon is covered with the jacket.

An aspect of the present disclosure is a manufacturing method of an intermittently-coupled type optical fiber ribbon, the method comprising:

a process of arranging a plurality of optical fibers having an outer diameter dimension of 0.22 mm or less in parallel and integrating every two optical fibers by bringing the optical fibers into contact with each other, thereby forming a plurality of ribbon type paired optical fibers;

an applying process of intermittently applying a coupling resin between the adjacent ribbon type paired optical fibers in the plurality of ribbon type paired optical fibers in a longitudinal direction; and

a curing process of curing the coupling resin, wherein

when the applying process and the curing process are performed,

a coupling part in which the adjacent ribbon type paired optical fibers are connected with each other and a non-coupling part in which the ribbon type paired optical fibers are not connected are intermittently provided in a longitudinal direction, and a center distance of optical fibers adjacent with the coupling part interposed therebetween between the ribbon type paired optical fibers is set to 0.28±0.03 mm.

### BRIEF DESCRIPTION OF DRAWINGS

FIG. 1 is a plan view illustrating one example of an intermittently-coupled type optical fiber ribbon according to this embodiment (illustrating a state where a non-coupling part is opened in a parallel direction);

FIG. 2 is a sectional view illustrating a state where the non-coupling part of the intermittently-coupled type optical fiber ribbon illustrated in FIG. 1 is closed in the parallel direction as seen along line A-A;

FIG. 3 is a schematic view illustrating a relation between a pitch of an intermittently-coupled type optical fiber ribbon of a first reference example and a V groove of a fusion machine in a fusion process;

FIG. 4 is a schematic view illustrating a relation between a pitch of an intermittently-coupled type optical fiber ribbon of a second reference example and the V groove of the fusion machine in the fusion process;

FIG. 5 is a schematic view illustrating a relation between a pitch of an intermittently-coupled type optical fiber ribbon according to this embodiment and the V groove of the fusion machine in the fusion process;

FIG. 6 is a schematic view illustrating one example of a manufacturing device of the intermittently-coupled type optical fiber ribbon according to this embodiment;

FIG. 7 is a plan view illustrating one example of an optical fiber cord according to this embodiment;

FIG. 8 is a plan view illustrating one example of an optical fiber cable according to this embodiment;

FIG. 9 is a plan view illustrating another example of the optical fiber cable according to this embodiment;

FIG. 10 is a sectional view illustrating a modification of the intermittently-coupled type optical fiber ribbon according to this embodiment;

FIG. 11 is a sectional view illustrating an intermittently-coupled type optical fiber ribbon of a first comparative example; and

FIG. 12 is a sectional view illustrating an intermittently-coupled type optical fiber ribbon of a second comparative example.

### DESCRIPTION OF EMBODIMENTS

### Problems to be Solved by Present Disclosure

In order to increase the density of an optical fiber cable or an optical fiber cord which stores an intermittently-coupled type optical fiber ribbon, an examination on the outer diameter of an optical fiber used in the intermittently-coupled type optical fiber ribbon is made from 0.25 mm (typical diameter, 250 μm) to 0.22 mm (220 μm), for example.

In a fusion machine which fuses the optical fiber ribbons to each other, a general optical fiber ribbon uses an optical fiber having a diameter of 0.25 mm. Thus, the pitch of the V groove is set to 0.25 mm. For this reason, when the above-described fusion machine is used for the intermittently-coupled type optical fiber ribbon in which the outer diameter of the optical fiber is 0.22 mm or less, the pitch of the V groove is different from an arrangement pitch of the optical fiber of the intermittently-coupled type optical fiber ribbon. Thus, the position of the optical fiber is deviated from the position of the V groove.

As described above, when the fusion machine is used in a state where the position of the optical fiber is deviated from the position of the V groove, there is a concern that the optical fibers cannot be placed one by one on each of the V grooves, and a normal splicing cannot be performed.

For this reason, for example, in the intermittently-coupled type optical fiber ribbon disclosed in JP-A-2013-88617 in which the outer diameter of the optical fiber is 0.22 mm or less, a gap is provided in each of spaces between the optical fibers, the gap is filled with an adhesive resin, and a center distance between the optical fibers matches with the pitch of the V groove of the fusion machine.

However, in the configuration of JP-A-2013-88617, the cross-sectional area of the intermittently-coupled type optical fiber ribbon is almost the same as that of the typical intermittently-coupled type optical fiber ribbon in which the outer diameter of the optical fiber is 0.25 mm. For this reason, although the outer diameter of the optical fiber is small, it is not possible to increase the density of the optical fiber cable or the optical fiber cord using the intermittently-coupled type optical fiber ribbon.

On object of the present disclosure is to provide an intermittently-coupled type optical fiber ribbon, an optical fiber cable and optical fiber cord using the intermittently-coupled type optical fiber ribbon, and a manufacturing method of the intermittently-coupled type optical fiber ribbon in which a fusion machine in which a pitch of a V groove is set to 0.25 mm can be used to fuse without any problems, and a density of the optical fiber cable and the optical fiber cord can be increased.

### Effect of Present Disclosure

According to the present disclosure, the fusion machine in which the pitch of the V groove is set to 0.25 mm can be used to fuse without any problems, and the density of the optical fiber cable and the optical fiber cord can be increased.

### Description of Embodiments of the Invention

First, the embodiment of the invention will be described as enumerated.

An intermittently-coupled type optical fiber ribbon according to one aspect is

(1) an intermittently-coupled type optical fiber ribbon in which a plurality of ribbon type paired optical fibers integrally formed by bringing two optical fibers into contact with each other are arranged in parallel, and a coupling part in which adjacent ribbon type paired optical fibers are connected to each other and a non-coupling part in which ribbon type paired optical fibers are not connected are intermittently provided in a longitudinal direction, in which

an outer diameter dimension of the optical fiber is 0.22 mm or less, and a center distance of optical fibers adjacent with the coupling part interposed therebetween between the adjacent ribbon type paired optical fibers is 0.28±0.03 mm.

According to the configuration, the optical fibers are arranged in the positions corresponding to the V grooves, respectively. Thus, the optical fibers can be placed one by one in each of the V grooves, and the fusion machine in which the pitch of the V groove is set to 0.25 mm can be used to fuse without any problems.

In addition, the dual-core optical fiber ribbon is used which is integrally formed by bringing two optical fibers having an outer diameter dimension of 0.22 mm or less into contact with each other. Thus, the width of the entire intermittently-coupled type optical fiber ribbon in a parallel direction is narrower than that of the conventional intermittently-coupled type optical fiber ribbon, and the sectional area of the intermittently-coupled type optical fiber ribbon can be reduced. Therefore, when the intermittently-coupled type optical fiber ribbon is used for the optical fiber cable or the optical fiber cord, the density of the optical fiber cable or the optical fiber cord can be increased.

(2) The number of optical fibers of the intermittently-coupled type optical fiber ribbon is N, a center distance between the M-th optical fiber and the M+1-th optical fiber with the coupling part interposed therebetween is 0.28±0.03 mm, a center distance between the M-1-th optical fiber and the M-th optical fiber is 0.20±0.03 mm, the N is a multiple of four, and the M is an even number.

The center distance between the M-1-th optical fiber and the M-th optical fiber, that is, between the optical fibers configuring the dual-core optical fiber ribbon is 0.20±0.03 mm. Thus, the width of the entire intermittently-coupled type optical fiber ribbon in the parallel direction is narrower than that of the conventional intermittently-coupled type optical fiber ribbon, and the sectional area of the intermittently-coupled type optical fiber ribbon can be reduced more easily. Therefore, when the intermittently-coupled type optical fiber ribbon is used for the optical fiber cable or the optical fiber cord, the density of the optical fiber cable or the optical fiber cord can be increased.

(3) A thickness of the intermittently-coupled type optical fiber ribbon is 0.26 mm or less.

When the thickness of the intermittently-coupled type optical fiber ribbon is suppressed to be 0.26 mm or less, the density of the optical fiber cable or the optical fiber cord can be increased.

(4) The coupling part is a coupling resin applied between the ribbon type paired optical fibers.

The coupling part in which the adjacent ribbon type paired optical fibers are connected by the coupling resin applied between the ribbon type paired optical fibers can be formed easily.

(5) The optical fiber has a glass fiber and two layers of coating layers coating the glass fiber, and

a Young's modulus of an inner coating layer in two layers of the coating layer is 0.5 MPa or less.

Since the Young's modulus of the inner coating layer of the optical fiber is 0.5 MPa or less, the deterioration of the lateral pressure characteristic caused by thinning the thickness the coating layer of the optical fiber can be suppressed.

An optical fiber cable according to one aspect includes:

(6) a cylindrical tube; and

a plurality of intermittently-coupled type optical fiber ribbons according to any one of the above (1) to (5), in which

the plurality of intermittently-coupled type optical fiber ribbons are covered with the tube.

According to the configuration, a plurality of intermittently-coupled type optical fiber ribbons according to any one of (1) to (5) are achieved. Thus, the density can be increased compared to the conventional optical fiber cable. In addition, when the number of optical fibers is the same, the outer diameter can be made smaller than that of the conventional optical fiber cable.

An optical fiber cable according to one aspect includes:

(7) a slot rod having a plurality of slot grooves; and

the plurality of intermittently-coupled type optical fiber ribbons according to any one of the above (1) to (5), in which

the plurality of intermittently-coupled type optical fiber ribbons are housed in each of the slot grooves.

According to the configuration, a plurality of intermittently-coupled type optical fiber ribbons according to any one of (1) to (5) are achieved. The density can be increased compared to the conventional optical fiber cable. In addition, when the number of optical fibers is the same, the outer diameter can be made smaller than that of the conventional optical fiber cable.

An optical fiber cord according to one aspect includes:

(8) a jacket; and

the intermittently-coupled type optical fiber ribbon according to any one of the above (1) to (5), in which

the intermittently-coupled type optical fiber ribbon is covered with the jacket.

According to the configuration, the outer diameter of the optical fiber cord can be reduced compared to the conventional one. In addition, the density of the optical fiber cord can be increased compared to the conventional one.

A manufacturing method of an intermittently-coupled type optical fiber ribbon according to one aspect includes:

(9) a process of arranging a plurality of optical fibers having an outer diameter dimension of 0.22 mm or less in parallel and integrating every two optical fibers by bringing the optical fibers into contact with each other, thereby forming a plurality of ribbon type paired optical fibers;

an applying process of intermittently applying a coupling resin between the adjacent ribbon type paired optical fibers in the plurality of ribbon type paired optical fibers in a longitudinal direction; and

a curing process of curing the coupling resin, in which

when the applying process and the curing process are performed,

a coupling part in which the adjacent ribbon type paired optical fibers are connected with each other and a non-coupling part in which the ribbon type paired optical fibers are not connected are intermittently provided in a longitudinal direction, and a center distance of optical fibers adjacent with the coupling part interposed therebetween between the ribbon type paired optical fibers is set to 0.28±0.03 mm.

According to the configuration of the intermittently-coupled type optical fiber ribbon manufactured by the manufacturing method, the optical fibers are arranged at the positions corresponding to the V grooves, respectively. Thus, the optical fibers can be placed one by one on each of the V grooves, and the fusion machine in which the pitch of the V groove is set to 0.25 mm can be used to fuse without any problems.

In addition, the dual-core optical fiber ribbon is used which is integrally formed by bringing two optical fibers having the outer diameter dimension of 0.22 mm or less into contact with each other. Thus, the width of the entire intermittently-coupled type optical fiber ribbon in the parallel direction is narrower than that of the conventional intermittently-coupled type optical fiber ribbon, and the sectional area of the intermittently-coupled type optical fiber ribbon can be reduced. Therefore, when the intermittently-coupled type optical fiber ribbon is used for the optical fiber cable or the optical fiber cord, the density of the optical fiber cable or the optical fiber cord can be increased.

### Details of Embodiments of the Invention

Hereinafter, the specific examples of the intermittently-coupled type optical fiber ribbon, the optical fiber cable, the optical fiber cord, and the manufacturing method of the intermittently-coupled type optical fiber ribbon according to the embodiments of the invention will be described with reference to the drawings.

Incidentally, the invention is not limited to the examples. The scope of the invention is defined by the claims, and it is intended to include all modifications within the scope of the claims and the equivalents thereof.

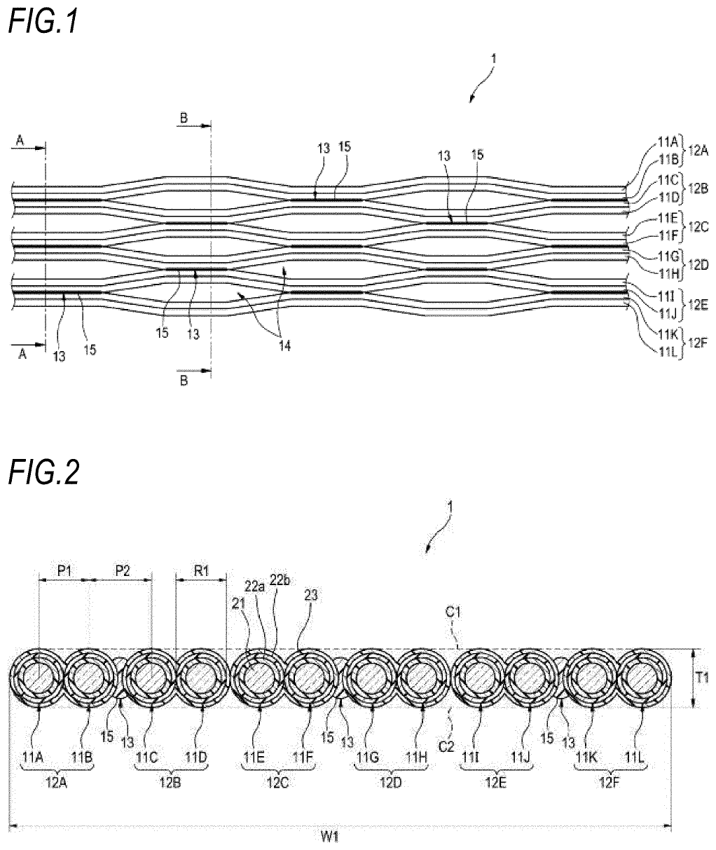

One example of the intermittently-coupled type optical fiber ribbon according to the embodiment will be described with reference to FIGS. 1 and 2.

As illustrated in FIGS. 1 and 2, in an intermittently-coupled type optical fiber ribbon 1, a plurality of (six in the example of FIGS. 1 and 2) ribbon type paired optical fibers 12A to 12F which are integrally formed by bringing two optical fibers into contact with each other are arranged in parallel. In addition, in the intermittently-coupled type optical fiber ribbon 1, a coupling part 13 in which adjacent ribbon type paired optical fibers are connected to each other and a non-coupling part 14 in which adjacent ribbon type paired optical fibers are not connected to each other are intermittently provided in the longitudinal direction. Incidentally, the plan view of FIG. 1 illustrates a state where the non-coupling part 14 is opened in the parallel direction, and the sectional view of FIG. 2 illustrates a cross section taken along line A-A of FIG. 1 in a state where the non-coupling part 14 is closed in the parallel direction. Incidentally, the “cross section” in this specification indicates a section of the intermittently-coupled type optical fiber ribbon when seen from the longitudinal direction (for example, the lateral direction of FIG. 1).

The dual-core optical fiber ribbon 12A is configured by optical fibers 11A and 11B, the dual-core optical fiber ribbon 12B is configured by optical fibers 11C and 11D, and the dual-core optical fiber ribbon 12C is configured by optical fibers 11E and 11F. In addition, the dual-core optical fiber ribbon 12D is configured by optical fibers 11G and 11H, the dual-core optical fiber ribbon 12E is configured by optical fibers 11I and 11J, and the dual-core optical fiber ribbon 12F is configured by optical fibers 11K and 11L.

The intermittently-coupled type optical fiber ribbon 1 is configured by the optical fibers 11A to 11L, the number of which is a multiple of four (twelve in the example of FIGS. 1 and 2).

For example, the optical fibers 11A to 11L are single coated optical fibers which each have a glass fiber 21 and two layers of coating layers 22a (inner coating layer) and 22b (outer coating layer) coating the glass fiber 21. It is preferable that the Young's modulus of the coating layer 22a is 0.5 MPa or less. A bent toughened glass fiber defined in ITU-T G.657.A/B may be used to improve the bending resistance of the glass portion.

In the optical fibers 11A to 11L, an outer diameter dimension R1 is formed to be 0.22 mm or less. For example, the diameter of the glass fiber 21 of the optical fibers 11A to 11L is 0.125 mm, and the diameter of the outer coating layer 22b is 0.20±0.02 mm. Incidentally, in the optical fibers 11A to 11L, in order to discriminate the optical fibers from each other, the coating layers 22b may be colored in colors different from each other, or coloring layers may be provided in the outer peripheries of the coating layers 22b.

The ribbon type paired optical fibers 12A to 12F are integrated by applying a tape resin 23 to each of the surfaces of two contacting optical fibers 11A and 11B, two contacting optical fibers 11C and 11D, two contacting optical fibers 11E and 11F, two contacting optical fibers 11G and 11H, two contacting optical fibers 11I and 11J, and two contacting optical fibers 11K and 11L. A thickness T1 of the ribbon type paired optical fibers 12A to 12F collectively coated by the tape resin 23, that is, the thickness T1 of the intermittently-coupled type optical fiber ribbon 1 is formed to be 0.26 mm or less. For example, an ultraviolet curable resin, a thermosetting resin, or the like is used for the tape resin 23. Incidentally, the tape resin 23 is preferably a resin having excellent peelability in order to facilitate the fiber separation process of the optical fibers 11A to 11L.

The coupling part 13 in which adjacent ribbon type paired optical fibers are connected to each other is formed by a coupling resin 15 applied between the ribbon type paired optical fibers.

For example, in FIG. 2, that is, in the position of line A-A of FIG. 1, the coupling resins 15 are applied between the ribbon type paired optical fibers 12A and 12B, between the ribbon type paired optical fibers 12C and 12D, and between the ribbon type paired optical fibers 12E and 12F. In addition, for example, in the position of line B-B of FIG. 1, the coupling resins 15 are applied between the ribbon type paired optical fibers 12B and 12C and between the ribbon type paired optical fibers 12D and 12E.

In a cross-sectional view of FIG. 2, the coupling resin 15 is applied such that the position of the upper end of the coupling resin 15 is not higher than the position of a broken line C1 which connects the upper ends of the tape resin 23 applied to the vicinity of the optical fibers 11A to 11L. In addition, similarly, the coupling resin is applied such that the position of the lower end of the coupling resin 15 is not lower than the position of the broken line C2 which connects the lower ends of the tape resin 23. For example, an ultraviolet curable resin, a thermosetting resin, or the like is used for the coupling resin 15. The coupling resin 15 is preferably a resin having excellent peelability in order to facilitate the fiber separation process of the optical fibers 11A to 11L.

In the intermittently-coupled type optical fiber ribbon 1, in a case where the number N of cores is set to a multiple of four, and M is set to an even number, a center distance (hereinafter, referred to as a pitch between fibers) P1 between the M-1-th optical fiber and the M-th optical fiber is formed to be 0.20±0.03 mm. In addition, a center distance P2 between the M-th optical fiber and the M+1-th optical fiber in a case where the coupling part 13 is interposed therebetween is formed to be 0.28±0.03 mm.

For example, in FIG. 2, the center distance P1 between the first optical fiber 11A and the second optical fiber 11B is formed to be 0.20±0.03 mm. In addition, the center distance P2 between the second optical fiber 11B and the third optical fiber 11C is formed to be 0.28±0.03 mm. That is, the center distance between two optical fibers included in the ribbon type paired optical fibers 12A to 12F is formed to be 0.20±0.03 mm, and the center distance of adjacent optical fibers between the adjacent ribbon type paired optical fibers in the coupling part 13 is formed to be 0.28±0.03 mm.

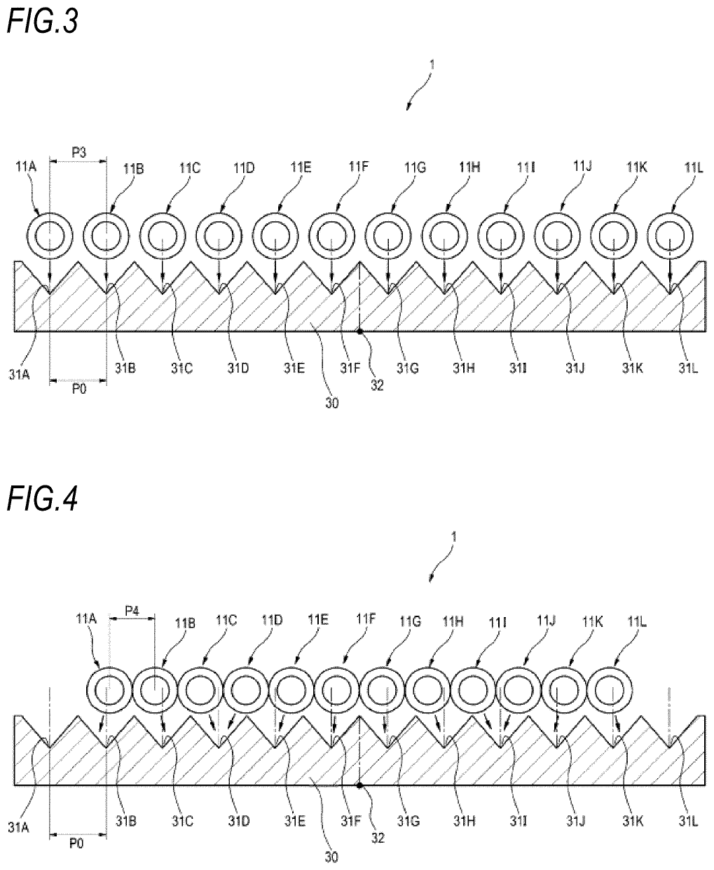

Next, the fusion of the optical fiber ribbon will be described with reference to FIGS. 3 to 5.

In a case where the optical fiber ribbons are connected, the multi-core fusion machine (not illustrated) can be used to collectively splice a plurality of optical fibers. As illustrated in FIGS. 3 to 5, a V groove base 30 which has a plurality (twelve in the example of FIGS. 3 to 5) of V grooves 31A to 31L for arranging optical fibers is provided in the multi-core fusion machine. The V grooves 31A to 31L are generally formed such that a pitch P0 is 0.25 mm in accordance with the international standard of the diameter of the optical fiber. In order to collectively splice a plurality of optical fibers, it is necessary to arrange the optical fibers one by one in order in the V grooves 31A to 31L of the V groove base 30, respectively.

FIG. 3 illustrates the fusion process of the intermittently-coupled type optical fiber ribbon of the first reference example in which the optical fibers 11A to 11L having an outer diameter dimension of 0.20 mm are arranged in parallel such that a center distance P3 between adjacent optical fibers is 0.25 mm. Incidentally, the pitch P0 of the V grooves 31A to 31L in the V groove base 30 of the multi-core fusion machine is formed to be 0.25 mm.

At the time of the fusion, as illustrated in FIG. 3, the optical fibers 11A to 11L in a state where a predetermined length of tape resin of the tip is removed are arranged above the V groove base 30. For example, the optical fibers 11A to 11L are arranged such that the center position 32 of the V groove base 30 in a direction in which the V grooves are arranged in parallel coincides with the center position in a direction in which the optical fibers 11A to 11L are arranged in parallel. In this state, a clamp lid (not illustrated) of the multi-core fusion machine is closed, and the optical fibers 11A to 11L are pushed down from above by the clamp lid.

In the case of the intermittently-coupled type optical fiber ribbon having such a configuration, the center distance P3 is formed to be equal to the pitch P0 of the V groove. Thus, the optical fibers 11A to 11L are arranged to face the V grooves 31A to 31L, respectively. For this reason, the optical fibers 11A to 11L are almost vertically pushed down and housed one by one in order in the V grooves 31A to 31L, respectively.

FIG. 4 illustrates a fusion process of an intermittently-coupled type optical fiber ribbon of a second reference example in which the optical fibers 11A to 11L having an outer diameter dimension of 0.20 mm are arranged in parallel such that a center distance P4 of adjacent optical fibers is 0.20 mm. Incidentally, the pitch P0 of the V grooves 31A to 31L in the V groove base 30 is formed to be 0.25 mm.

During the fusing, as illustrated in FIG. 4, the optical fibers 11A to 11L are arranged above the V groove base 30 such that the center positions are aligned similarly to FIG. 3. In addition, the clamp lid of the multi-core fusion machine is closed, and the optical fibers 11A to 11L are pushed down from above.

In the case of the intermittently-coupled type optical fiber ribbon configured as above, the center distance P4 of the optical fibers 11A to 11L is formed smaller than the pitch P0 of the V grooves 31A to 31L, and the optical fibers 11A to 11L are arranged to gather in the direction of the center position 32 of the V groove base 30. For this reason, the optical fibers 11A to 11L are pushed down along the groove walls of the V grooves in the directions of the arrows, for example. Therefore, the optical fibers 11A to 11L cannot be housed in order in the V grooves 31A to 31L. For example, in some cases, the optical fiber is not housed in the end V grooves 31A and 31L or the like.

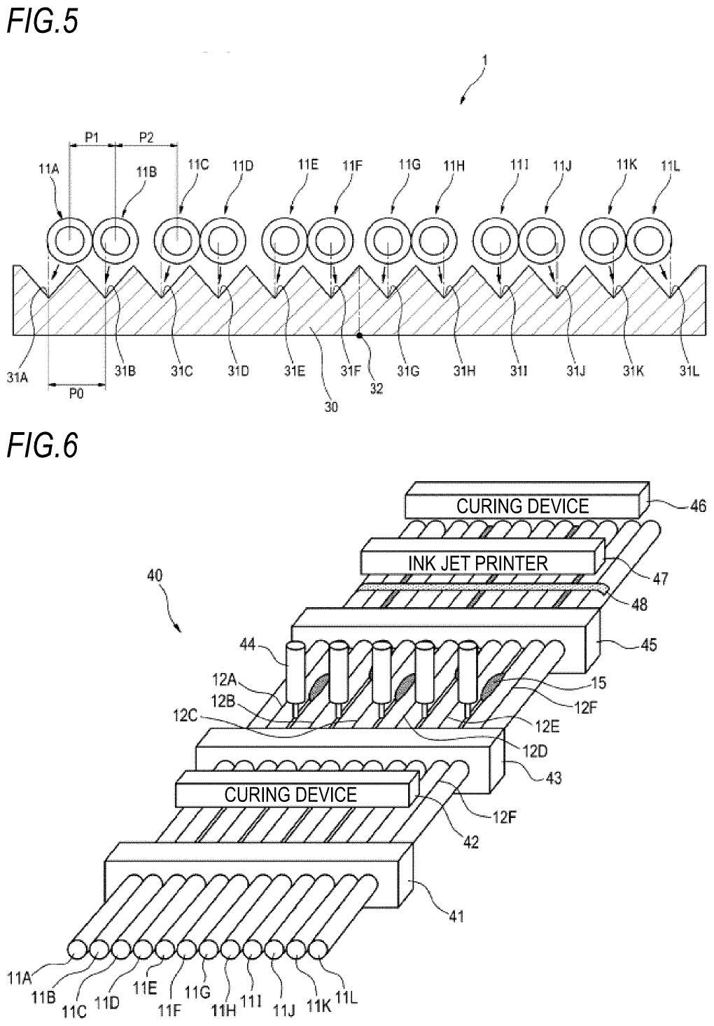

FIG. 5 illustrates the fusion process of the intermittently-coupled type optical fiber ribbon 1 illustrated in FIG. 2 according to this embodiment. During the fusing, as illustrated in FIG. 5, the optical fibers 11A to 11L are arranged above the V groove base 30 such that the center positions are aligned similarly to FIG. 3. In addition, the clamp lid of the multi-core fusion machine is closed, and the optical fibers 11A to 11L are pushed down from above.

In the case of the intermittently-coupled type optical fiber ribbon 1 according to this embodiment, the center distance P1 between the optical fibers in the dual-core optical fiber ribbon is formed smaller than the pitch P0 of the V groove. However, the center distance P2 of the optical fibers adjacent with the coupling part 13 interposed therebetween between adjacent ribbon type paired optical fibers is formed larger than the pitch P0 of the V groove. For this reason, the optical fibers 11A to 11L are arranged to gather overall in the direction of the center position 32 of the V groove base 30. However, in the case of being pushed down by the clamp lid, the optical fibers are guided along the groove walls of the V grooves in the directions of the arrows illustrated in FIG. 5. Accordingly, the optical fibers 11A to 11L are housed one by one in order in the V grooves 31A to 31L, respectively.

Incidentally, in the above-described configuration, the optical fibers in a state where the tape resins are removed are housed in the V grooves 31A to 31L. However, for example, the coating layer may be removed in addition to the tape resin, so that only the glass fibers are housed in the V grooves 31A to 31L.

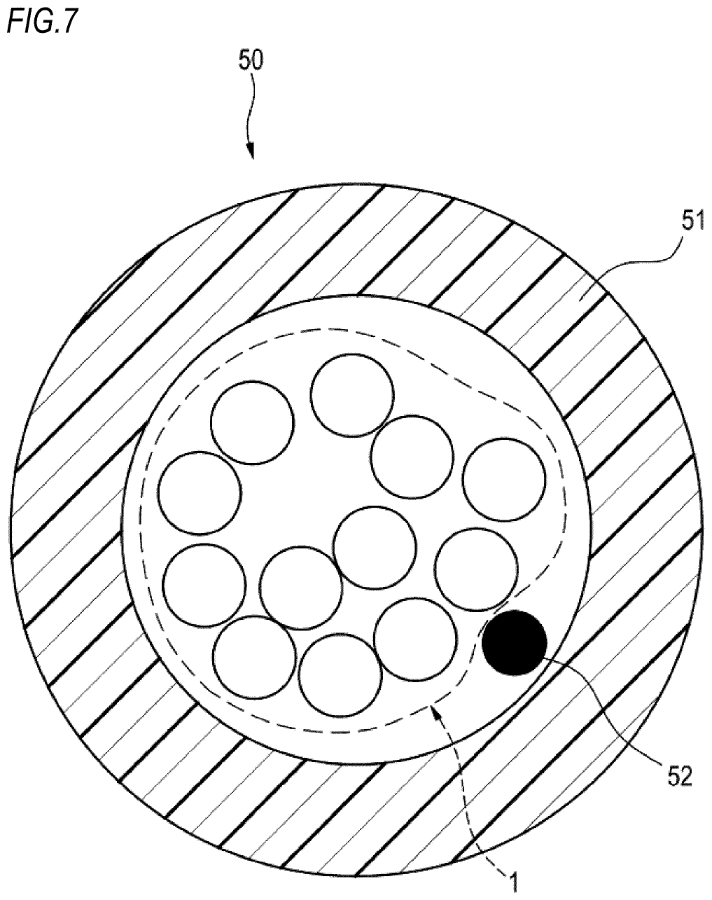

Next, the manufacturing method of the intermittently-coupled type optical fiber ribbon 1 will be described with reference to FIG. 6.

First, optical fibers are drawn such that the diameter of the glass fiber 21 is 0.125 mm, and the diameter of the coating layer 22b is 0.20 mm, thereby manufacturing the optical fibers 11A to 11L. Incidentally, in a case where distinctive characters are given to the optical fibers, for example, the coating layer 22b is colored to manufacture the colored optical fibers 11A to 11L. In this example, the optical fibers 11A to 11L having an outer diameter of about 0.21 mm are manufactured by coloring.

Twelve optical fibers 11A to 11L are prepared, and optical fibers are passed through a coating die 41 of the manufacturing device 40 in a state where the optical fibers are brought into contact with each other two by two. By the coating die 41, the surfaces of two optical fibers 11A and 11B, 11C and 11D, 11E and 11F, 11G and 11H, 11I and 11J, and 11K and 11L are coated with the tape resins 23 (see FIG. 2).

The optical fibers coated with the tape resins 23 are irradiated by a curing device 42 with ultraviolet rays, and the tape resins 23 are cured. Accordingly, six ribbon type paired optical fibers 12A to 12F in which the center distance P1 of the optical fibers is 0.20±0.03 mm are manufactured.

Subsequently, the ribbon type paired optical fibers 12A to 12F are arranged in parallel and are passed through a positioning die 43. A gap between the ribbon type paired optical fibers is made by the positioning die 43 such that the center distance of adjacent optical fibers between adjacent ribbon type paired optical fibers is 0.28±0.03 mm.

Subsequently, by a coating device 44 such as a dispenser, the coupling resin 15 is intermittently applied between the ribbon type paired optical fibers. For example, the coupling resin 15 is applied to the position of the coupling part 13 as illustrated in FIG. 1. Specifically, at the position of line A-A of FIG. 1, the coupling resins 15 are applied between the ribbon type paired optical fibers 12A and 12B, between the ribbon type paired optical fibers 12C and 12D, and between the ribbon type paired optical fibers 12E and 12F.

Subsequently, the ribbon type paired optical fibers in a state where the coupling resins 15 are applied are arranged in parallel to pass through an extending die 45. The coupling resin 15 is pressed vertically by a protrusion part provided in the extending die 45 to extend by a predetermined length (the length of the coupling part 13).

Subsequently, for example, in a case where an ultraviolet curable resin is used as the coupling resin 15, the ribbon type paired optical fibers in which the coupling resin 15 is extended are irradiated with ultraviolet rays by the curing device 46 to cure the coupling resin 15. Accordingly, the intermittently-coupled type optical fiber ribbon 1 is manufactured completely such that the center distance between the optical fibers included in the dual-core optical fiber ribbon is 0.20±0.03 mm, and the center distance of adjacent optical fibers between adjacent ribbon type paired optical fibers is 0.28±0.03 mm.

Incidentally, in a process before the optical fibers pass through the curing device 46, for example, an identification mark 48 may be printed on the optical fiber or the like by an ink jet printer 47.

In the intermittently-coupled type optical fiber ribbon 1 manufactured as described above, as illustrated in FIG. 5, when the fusion machine in which the pitch of the V grooves 31A to 31L is set to 0.25 mm is used, the optical fibers 11A to 11L are arranged in the positions corresponding to the V grooves 31A to 31L, respectively. Thus, the optical fibers 11A to 11L can be housed one by one in the V grooves 31A to 31L, respectively.

In addition, the ribbon type paired optical fibers 12A to 12F are integrally formed by bringing two optical fibers having an outer diameter dimension R1 of 0.22 mm or less into contact with each other, and are formed such that the center distance P1 between the optical fibers configuring the dual-core optical fiber ribbon is 0.20±0.03 mm. For this reason, the width W1 of the entire intermittently-coupled type optical fiber ribbon 1 in the parallel direction can be narrower than the width of the conventional intermittently-coupled type optical fiber ribbon. The cross-sectional area of the intermittently-coupled type optical fiber ribbon 1 can be reduced. Therefore, the density of the optical fiber cable or the optical fiber cord can be increased by using the intermittently-coupled type optical fiber ribbon 1 for the optical fiber cable or the optical fiber cord.

When the thickness T1 of the intermittently-coupled type optical fiber ribbon 1 is suppressed to be 0.26 mm or less, the cross-sectional area can be reduced further, and the density of the optical fiber cable or the optical fiber cord can be increased.

The coupling part 13 in which adjacent ribbon type paired optical fibers are connected can be formed easily by the coupling resin 15 applied between the ribbon type paired optical fibers. In addition, since the Young's modulus of the inner coating layer 22a of the optical fibers 11A to 11L is 0.5 MPa or less, the deterioration of the lateral pressure characteristic caused by thinning the thickness of the coating layers (22a and 22b) of the optical fibers 11A to 11L can be suppressed.

According to the manufacturing method of the intermittently-coupled type optical fiber ribbon 1, the intermittently-coupled type optical fiber ribbon configured such that even the fusion machine in which the pitch of the V groove is set to 0.25 mm can fuse without any problems can be manufactured.

The dual-core optical fiber ribbon in which the center distance P1 between the optical fibers is 0:20±0.03 mm can be manufactured by the optical fiber having an outer diameter dimension R1 of 0.22 mm or less, and the intermittently-coupled type optical fiber ribbon 1 can be manufactured by applying the coupling resin 15 between the ribbon type paired optical fibers. For this reason, the width W1 of the entire intermittently-coupled type optical fiber ribbon in the parallel direction can be narrowed to reduce the cross-sectional area of the intermittently-coupled type optical fiber ribbon. Accordingly, in a case where the intermittently-coupled type optical fiber ribbon is used for the optical fiber cable or the optical fiber cord, the density of the optical fiber cable or the optical fiber cord can be increased.

Next, one example of the optical fiber cord according to the embodiment will be described with reference to FIG. 7.

FIG. 7 is a sectional view illustrating an optical fiber cord 50 using the above-described intermittently-coupled type optical fiber ribbon 1.

The optical fiber cord 50 has a jacket 51 and the intermittently-coupled type optical fiber ribbon 1. For example, the intermittently-coupled type optical fiber ribbon 1 is covered with the cylindrical jacket 51. In addition, the intermittently-coupled type optical fiber ribbon 1 may be bundled by an intervenient layer 52 made of Kevlar.

Since the cross-sectional area can be reduced compared to the conventional intermittently-coupled type optical fiber ribbon, the optical fiber cord 50 can be formed such that the outer diameter is smaller than that of the conventional optical fiber cord. In addition, the density of the optical fiber cord 50 can be increased compared to the conventional one.

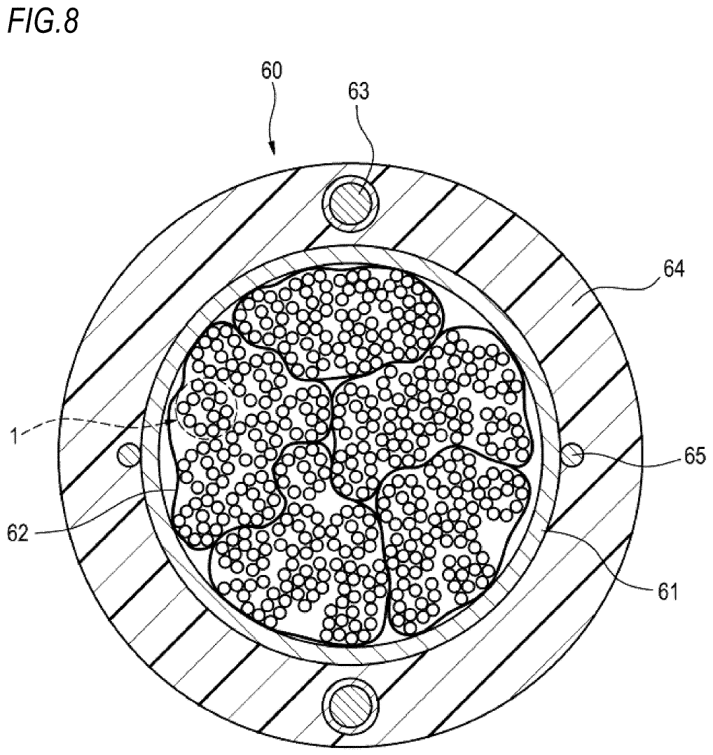

Next, one example of the optical fiber cable according to the embodiment will be described with reference to FIG. 8.

FIG. 8 is a sectional view illustrating a slot-less optical fiber cable 60 using the above-described intermittently-coupled type optical fiber ribbon 1.

The optical fiber cable 60 has a cylindrical tube 61 and a plurality of intermittently-coupled type optical fiber ribbons 1. The plurality of intermittently-coupled type optical fiber ribbons 1 may be bundled by an intervenient layer 62 such as aramid fibers. In addition, the plurality of intermittently-coupled type optical fiber ribbons 1 may have markings different from each other. Further, the plural bundled intermittently-coupled type optical fiber ribbons 1 are twisted, and a resin to be a tube 61 is extrusion-molded in the periphery thereof. The intermittently-coupled type optical fiber ribbons are covered with a jacket 64 together with a tension member 63. Incidentally, when waterproofness is required, a water absorptive yarn may be inserted into the tube 61. For example, hard materials such as polybutylene terephthalate and high density polyethylene are used as the resin to be the tube 61. Incidentally, a tear string 65 may be provided.

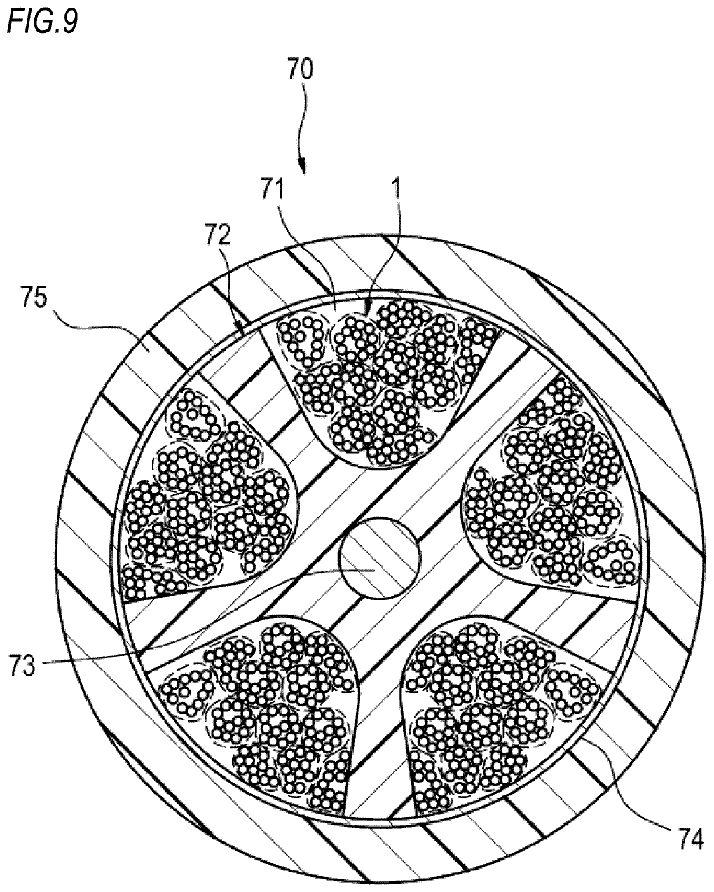

Another example of the optical fiber cable according to the embodiment will be described with reference to FIG. 9.

FIG. 9 is a sectional view illustrating a slot optical fiber cable 70 using the above-described intermittently-coupled type optical fiber ribbon 1.

The optical fiber cable 70 has a slot rod 72 having a plurality of slot grooves 71 and the plurality of intermittently-coupled type optical fiber ribbons 1. The optical fiber cable 70 has a structure in which the plurality of slot grooves 71 are radially provided in the slot rod 72 having a tension member 73 at the center. Incidentally, the plurality of slot grooves 71 may be provided to be twisted in a spiral shape, a SZ shape, or the like in the longitudinal direction of the optical fiber cable 70. Each slot groove 71 houses the plurality of intermittently-coupled type optical fiber ribbons 1 which are disassembled from a parallel state into a dense state. Each intermittently-coupled type optical fiber ribbon 1 may be bundled with an identification bundle material. A press winding tape 74 is wound around the slot rod 72, and a jacket 75 is formed around the press winding tape 74.

Since the cross-sectional area can be made smaller than that of the conventional intermittently-coupled type optical fiber ribbon, the densities of the slot-less optical fiber cable 60 and the slot optical fiber cable 70 can be increased compared to the conventional optical fiber cable. In addition, when the number of optical fibers is the same, the outer diameter can be made smaller than that of the conventional optical fiber cable.

### Modification

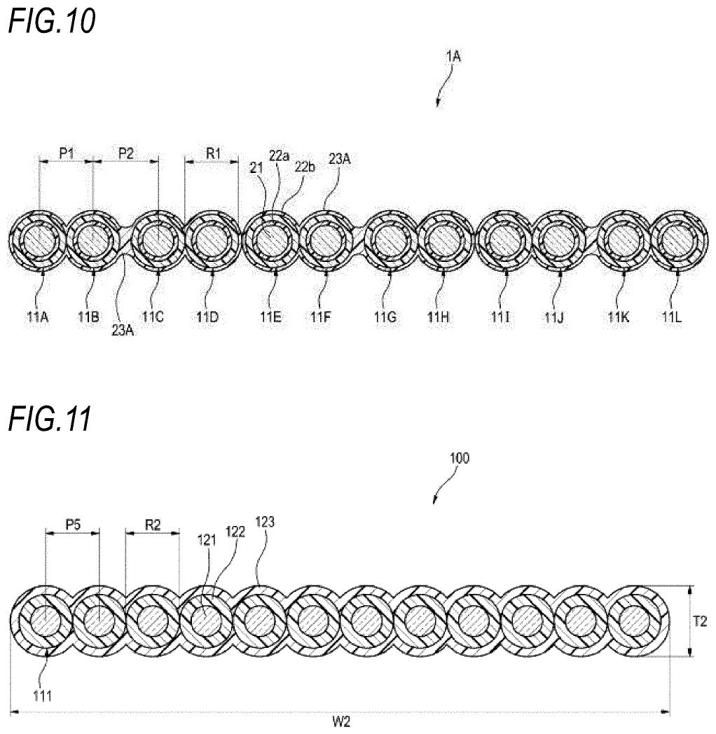

Next, a modification of the intermittently-coupled type optical fiber ribbon 1 will be described with reference to FIG. 10. Incidentally, the parts denoted by the same reference numeral as those of the above-described embodiment have the same functions, and thus the repetitive description will be omitted.

Unlike the intermittently-coupled type optical fiber ribbon 1, an intermittently-coupled type optical fiber ribbon 1A according to the modification is not configured to be formed by intermittently applying the coupling resin 15 between the ribbon type paired optical fibers.

As illustrated in FIG. 10, the intermittently-coupled type optical fiber ribbon 1A is formed such that the center distance P2 between every two optical fibers is 0.28±0.03 mm. For example, in FIG. 10, the center distance between the optical fibers 11B and 11C is formed to be 0.28±0.03 mm. In addition, the center distance between the optical fibers 11A and 11B is formed to be 0.20±0.03 mm. The surfaces of twelve optical fibers 11A to 11L arranged in parallel are collectively coated with a tape resin 23A.

In the manufacturing method of the intermittently-coupled type optical fiber ribbon 1A, first, the optical fiber ribbon in which a plurality of cores (twelve cores in FIG. 10) are connected to be collectively coated with the tape resin 23A is manufactured such that the center distances of the optical fibers are the above-described values. Further, in the coupling part between the optical fibers formed such that the center distance is 0.28±0.03 mm, for example, cuts (non-coupling part) are intermittently formed in the longitudinal direction by a cutter blade, so as to manufacture the intermittently-coupled type optical fiber ribbon 1A.

The intermittently-coupled type optical fiber ribbon 1A configured as above exhibits the same effect as the above-described intermittently-coupled type optical fiber ribbon 1.

### Embodiments

The description will be given about the comparison result of the cross-sectional areas in the intermittently-coupled type optical fiber ribbons of the embodiment and the first and second comparative examples.

### First Comparative Example

As illustrated in FIG. 11, an intermittently-coupled type optical fiber ribbon 100 of the first comparative example has a structure in which optical fibers 111 having an outer diameter R2 of 0.25 mm are brought into contact with each other to be arranged in parallel, and a tape resin 123 is applied therearound. A pitch P5 between the cores of the intermittently-coupled type optical fiber ribbon 100 is 0.25 mm, and the width W2 of the intermittently-coupled type optical fiber ribbon 100 is 3.04 mm. Incidentally, the structure of the optical fiber 111 is a single coated optical fiber having a glass fiber 121 and a coating layer 122 coating the glass fiber 121.

When the intermittently-coupled type optical fiber ribbon 100 is simply approximated as an aggregate of the optical fiber, and a thickness T2 of the aggregate is set to 0.285 mm, the cross-sectional area of the intermittently-coupled type optical fiber ribbon 100 is 0.765 mm².

### Second Comparative Example

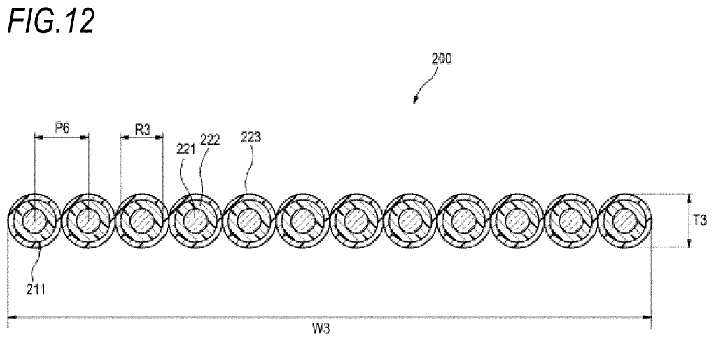

As illustrated in FIG. 12, an intermittently-coupled type optical fiber ribbon 200 of a second comparative example has a structure in which the peripheries of optical fibers 211 having an outer diameter R3 of 0.20 mm are each coated with a tape resin 223, and the optical fibers are arranged in parallel such that a pitch P6 between cores is 0.25 mm. The width W3 of the intermittently-coupled type optical fiber ribbon 200 is 3.00 mm. Incidentally, the structure of the optical fiber 211 is a single coated optical fiber having a glass fiber 221 and a coating layer 222 coating the glass fiber 221.

When the intermittently-coupled type optical fiber ribbon 200 is simply approximated as an aggregate of the optical fiber, and a thickness T3 of the aggregate is 0.25 mm, the cross-sectional area of the intermittently-coupled type optical fiber ribbon 200 is 0.589 mm², which means a reduction rate of about 23% in a cross-sectional area ratio compared to the first comparative example.

### Embodiment

In the intermittently-coupled type optical fiber ribbon 1 of the embodiment illustrated in FIGS. 1 and 2, the intermittently-coupled type optical fiber ribbon of the embodiment is formed such that the outer diameter R1 of the optical fibers 11A to 11L is set to 0.20 mm, the pitch P1 between cores is set to 0.20 mm, and the pitch P2 is set to 0.28 mm. At that time, the thickness T1 of the intermittently-coupled type optical fiber ribbon 1 is 0.24 mm, and the width W1 is 2.69 mm.

When the intermittently-coupled type optical fiber ribbon 1 is approximated as an aggregate of fibers having an outer diameter of 0.24 mm, the cross-sectional area is 0.543 mm², which means a reduction rate of about 29% in the cross-sectional area ratio compared to the first comparative example.

While the outer diameter of the optical fiber of the first comparative example is typically 0.25 mm, the outer diameters of the optical fiber of the second comparative example and the embodiment are 0.20 mm smaller than the typical one. For this reason, the cross-sectional area of the intermittently-coupled type optical fiber ribbon of the second comparative example or the embodiment is reduced compared to that of the first comparative example. However, the reduction rate is about 29% in the embodiment, which is larger than about 23% of the second comparative example.

In this way, even when the outer diameter of the optical fiber is the same, in the embodiment having a structure of the intermittently-coupled type optical fiber ribbon 1 of the embodiment, the sectional area can be reduced compared to the second comparative example which is the conventional intermittently-coupled type optical fiber ribbon. In addition, problems do not occur during the fusing.

Hereinbefore, the invention is described in detail with reference to a specific embodiment. However, it is clear for those skilled in the art that it is possible to perform various alterations or modifications without departing from the spirit and range of the invention. In addition, the number, position, shape, or the like of the above-described components are not limited to the embodiment, but can be modified to the number, position, shape, or the like suitable for implementing the invention.

### REFERENCE SIGNS LIST

1 intermittently-coupled type optical fiber ribbon
11A˜11L optical fiber
12A˜12F dual-core optical fiber ribbon
14 non-coupling part
15 coupling resin
21 glass fiber
22a, 22b coating layer
23 tape resin
31A˜31L V groove
41 coating die
42, 46 curing device
44 coating device
50 optical fiber cord
51 jacket
60, 70 optical fiber cable
61 cylindrical tube
71 slot groove
72 slot rod
P1, P2 center distance
R1 outer diameter dimension
T1 thickness

1: An intermittently-coupled type optical fiber ribbon in which a plurality of ribbon type paired optical fibers each of which is integrally formed by bringing two optical fibers into contact with each other are arranged in parallel, and a coupling part in which adjacent ribbon type paired optical fibers are connected to each other and a non-coupling part in which ribbon type paired optical fibers are not connected are intermittently provided in a longitudinal direction, wherein
an outer diameter dimension of the optical fiber is 0.22 mm or less, and a center distance of optical fibers adjacent with the coupling part interposed therebetween between the adjacent ribbon type paired optical fibers is 0.28±0.03 mm.

2: The intermittently-coupled type optical fiber ribbon according to claim 1, wherein
the number of optical fibers of the intermittently-coupled type optical fiber ribbon is N, a center distance between the M-th optical fiber and the M+1-th optical fiber with the coupling part interposed therebetween is 0.28±0.03 mm, a center distance between the M−1-th optical fiber and the M-th optical fiber is 0.20±0.03 mm, the N is a multiple of four, and the M is an even number.

3: The intermittently-coupled type optical fiber ribbon according to claim 1, wherein
a thickness of the intermittently-coupled type optical fiber ribbon is 0.26 mm or less.

4: The intermittently-coupled type optical fiber ribbon according to claim 1, wherein
the coupling part is a coupling resin applied between the ribbon type paired optical fibers.

5: The intermittently-coupled type optical fiber ribbon according to claim 1, wherein
the optical fiber has a glass fiber and two layers of coating layers coating the glass fiber, and
a Young's modulus of an inner coating layer in two layers of the coating layer is 0.5 MPa or less.

6: An optical fiber cable comprising:
a cylindrical tube; and
a plurality of intermittently-coupled type optical fiber ribbons according to claim 1, wherein
the plurality of intermittently-coupled type optical fiber ribbons are covered with the tube.

7: An optical fiber cable comprising:
a slot rod having a plurality of slot grooves; and
the plurality of intermittently-coupled type optical fiber ribbons according to claim 1, wherein
the plurality of intermittently-coupled type optical fiber ribbons are housed in each of the slot grooves.

8: An optical fiber cord comprising:
a jacket; and
the intermittently-coupled type optical fiber ribbon according to claim 1, wherein
the intermittently-coupled type optical fiber ribbon is covered with the jacket.

9: A manufacturing method of an intermittently-coupled type optical fiber ribbon, the method comprising:
a process of arranging a plurality of optical fibers having an outer diameter dimension of 0.22 mm or less in parallel and integrating every two optical fibers by bringing the optical fibers into contact with each other, thereby forming a plurality of ribbon type paired optical fibers;
an applying process of intermittently applying a coupling resin between the adjacent ribbon type paired optical fibers in the plurality of ribbon type paired optical fibers in a longitudinal direction; and
a curing process of curing the coupling resin, wherein
when the applying process and the curing process are performed,
a coupling part in which the adjacent ribbon type paired optical fibers are connected with each other and a non-coupling part in which the ribbon type paired optical fibers are not connected are intermittently provided in a longitudinal direction, and a center distance of optical fibers adjacent with the coupling part interposed therebetween between the ribbon type paired optical fibers is set to 0.28±0.03 mm.
